(19) United States
(12) Patent Application Publication
(10) Pub. No.: US 2005/0117499 A1
(43) Pub. Date: Jun. 2, 2005

(54) Optical information recording and reproducing apparatus, method and computer program for determining a value of current supplied to a laser light source, and computer readable storage medium storing the program

(75) Inventor: Akihiro Sugano, Kanagawa-ken (JP)

Correspondence Address: DICKSTEIN SHAPIRO MORIN & OSHINSKY LLP, 2101 L Street, NW, Washington, DC, 20037, US

(73) Assignee: Ricoh Company, Ltd., Tokyo (JP)

(21) Appl. No.: 10/998,982

(22) Filed: Nov. 30, 2004

(30) Foreign Application Priority Data
Dec. 2, 2003 (JP) 2003-402940

(51) Int. Cl. G11B 7/00

(52) U.S. Cl. 369/116; 369/47.53

(57) ABSTRACT

In a method of determining a value of current supplied to a laser diode, a laser light beam of predetermined power intensity is emitted continuously from a laser diode at a constant power intensity value during a predetermined period to a test area in a recording medium before performing an OPC operation. A laser efficiency value of the laser diode is obtained based on a relation between the predetermined power intensity of the laser light beam and a value of current supplied to the laser diode during the predetermined period. Then, third and second values of current required to be supplied to the laser diode to emit the laser light beams of third and second power intensity from the laser diode, respectively, when recording test data into the test area, are determined based on the laser efficiency value of the laser diode.

### CROSS-REFERENCE TO RELATED APPLICATIONS

This application claims priority to Japanese Patent Application No. 2003-402940 filed in the Japanese Patent Office on Dec. 2, 2003, the disclosure of which is incorporated herein by reference.

### BACKGROUND OF THE INVENTION

1. Field of the Invention

The present invention relates to an optical information recording and reproducing apparatus that records information on and reproduces information from an optical disk, such as a CD-R disk, a CD-RW disk, and a DVD disk by use of a laser. The present invention further relates to a method and a computer program for determining a value of current supplied to a laser light source that emits a laser light beam to record information on and reproduce information from a recording medium, such as a CD-R disk, a CD-RW disk, and a DVD disk. The present invention further relates to a computer readable storage medium storing the computer program.

2. Discussion of the Related Art

In a conventional optical information recording and reproducing apparatus, such as a CD-R drive and a CD-RW drive, which records information data into and reproduces information data from an optical disk, a bias power current is calculated from a reproduction power current control value of a servo amplifier for the reproduction immediately before recording, an erase power is detected by a sample-hold circuit, and the emission of a laser light beam is controlled based on the detected value. Further, a peak power is calculated from an erase power current. This technology is described, for example, in Published Japanese Patent application No. 2001-229561.

However, in such a conventional optical information recording and reproducing apparatus, the peak power calculated from the erase power current varies due to the variation of the erase power obtained by a sample-holding operation.

Generally, in an optical information recording and reproducing apparatus, before recording information data into an optical disk, a so-called optimum power control (OPC) needs to be performed to determine an optimum intensity value of a recording power of a laser light beam. When performing an OPC operation, test data is recorded on a test area of an optical disk by variously changing an intensity value of a recording power of a laser light beam emitted from a laser light source step by step from a minimum intensity value to a maximum intensity value. The intensity value of the recording power of the laser light beam that provides a highest recording quality is detected by reproducing the recorded test data, and is determined as an optimum intensity value of the recording power of the laser light beam. In such an OPC operation, if a recording power of a laser light beam varies when recording test data on a test area of an optical disk, an optimum intensity value of a recording power of a laser light beam cannot be adequately determined.

### SUMMARY OF THE INVENTION

According to an aspect of the present invention, an optical information recording and reproducing apparatus includes a laser light source configured to emit a digitally modulated laser light beam to an optical recording medium including a light-emitting power calibration area that is used for determining an optimum recording power intensity value of the laser light beam emitted from the laser light source and that includes a test area including a plurality of partitions into which test data is recorded and includes a count area including a plurality of partitions corresponding to the partitions of the test area. The laser light beam emitted from the laser light source includes a laser light beam of first power intensity, a laser light beam of second power intensity greater than the first power intensity, and a laser light beam of third power intensity greater than the second power intensity. The optical information recording and reproducing apparatus further includes a laser light source drive mechanism configured to supply current to the laser light source and drive the laser light source, a light-emitting power detecting mechanism configured to detect a light-emitting power of the laser light beam emitted from the laser light source, a power intensity adjusting mechanism configured to adjust a power intensity of the laser light beam emitted from the laser light source based on the light-emitting power detected by the light-emitting power detecting mechanism by changing a value of the current supplied to the laser light source by the laser light source drive mechanism, and an optimum recording power intensity value determining mechanism configured to determine the optimum recording power intensity value of the laser light beam emitted from the laser light source by recording the test data into one of the partitions of the test area with at least the laser light beam of the third power intensity and the laser light beam of the second power intensity while variously changing the value of the third power intensity and the value of the second power intensity, and by reproducing the test data. The optical information recording and reproducing apparatus further includes a laser efficiency value obtaining mechanism configured to obtain a laser efficiency value of the laser light source by causing the laser light source to emit a laser light beam of predetermined power intensity continuously to the one of the partitions of the test area at a constant power intensity value before recording the test data into the one of the partitions, by obtaining a plurality of values of current supplied to the laser light source during a period in which the laser efficiency value obtaining mechanism causes the laser light source to emit the laser light beam of the predetermined power intensity, and by calculating the laser efficiency value of the laser light source based on the plurality of obtained values of current, and a current value determining mechanism configured to determine a third value of current required to be supplied to the laser light source to emit the laser light beam of the third power intensity when recording the test data into the one of the partitions of the test area based on the laser efficiency value of the laser light source obtained by the laser efficiency value obtaining mechanism, and configured to determine a second value of current required to be supplied to the laser light source to emit the laser light beam of the second power intensity at the start of recording the test data into the one of the partitions of the test area based on the laser efficiency value of the laser light source obtained by the laser efficiency value obtaining mechanism.

According to another aspect of the present invention, a method of determining a value of current supplied to a laser light source that emits at least a laser light beam of first power intensity, a laser light beam of second power intensity greater than the first power intensity, and a laser light beam of third power intensity greater than the second power intensity to record information data into a recording medium, includes steps of causing the laser light source to emit a laser light beam of predetermined power intensity continuously at a constant power intensity value during a predetermined period to a test area in the recording medium to be used for determining an optimum recording power intensity value of the laser light beam emitted from the laser light source, obtaining a laser efficiency value of the laser light source based on a relation between the predetermined power intensity of the laser light beam emitted continuously from the laser light source to the test area and a value of current supplied to the laser light source during the predetermined period in which the laser light beam of the predetermined power intensity is continuously emitted to the test area, determining a third value of current required to be supplied to the laser light source to emit the laser light beam of the third power intensity from the laser light source when recording test data into the test area based on the laser efficiency value of the laser light source, and determining a second value of current required to be supplied to the laser light source to emit the laser light beam of the second power intensity from the laser light source at the start of recording the test data into the test area based on the laser efficiency value of the laser light source.

According to another aspect of the present invention, a computer program includes program code means that, when executed by a controller of an optical information recording and reproducing apparatus, instructs the apparatus to carry out a method of determining a value of current supplied to a laser light source that emits at least a laser light beam of first power intensity, a laser light beam of second power intensity greater than the first power intensity, and a laser light beam of third power intensity greater than the second power intensity to record information data into a recording medium, the method including steps of causing the laser light source to emit a laser light beam of predetermined power intensity continuously at a constant power intensity value during a predetermined period to a test area in the recording medium to be used for determining an optimum recording power intensity value of the laser light beam emitted from the laser light source, obtaining a laser efficiency value of the laser light source based on a relation between the predetermined power intensity of the laser light beam emitted continuously from the laser light source to the test area and a value of current supplied to the laser light source during the predetermined period in which the laser light beam of the predetermined power intensity is continuously emitted to the test area, determining a third value of current required to be supplied to the laser light source to emit the laser light beam of the third power intensity from the laser light source when recording test data into the test area based on the laser efficiency value of the laser light source, and determining a second value of current required to be supplied to the laser light source to emit the laser light beam of the second power intensity from the laser light source at the start of recording the test data into the test area based on the laser efficiency value of the laser light source.

According to yet another aspect of the present invention, a computer readable storage medium stores the above-described computer program.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a diagram for explaining a laser light beam emitted from a laser light source to a CD-RW disk according to an embodiment of the present invention;

FIG. 2 is a block diagram of a circuit of a laser controller that performs a constant power control of a light beam emission to a CD-RW disk;

FIG. 3 is a time chart showing a relation between a voltage value Vs(P1) output from a first sample-hold (S/H) circuit and an output of a first comparator in a digital control;

FIG. 4 is a time chart showing a relation between a voltage value Vs(P2) output from a second sample-hold (S/H) circuit and an output of a second comparator in a digital control;

FIG. 5 is a characteristic diagram showing a relation between a current value for driving a laser diode and a light-emitting power of the laser diode;

FIG. 6A is a diagram showing a cross section taken along a radial direction of an optical disk;

FIG. 6B is a diagram showing a test area and a count area in a power calibration area;

FIG. 7 is a block diagram of a configuration of an optical information recording and reproducing apparatus according to an embodiment of the present invention;

FIG. 8 is a flowchart of current value determining operation steps of a CPU according to an embodiment of the present invention; and

FIG. 9 is a block diagram of a configuration of an information processing system including the optical information recording and reproducing apparatus of FIG. 7.

### DESCRIPTION OF THE PREFERRED EMBODIMENTS

Preferred embodiments of the present invention are described in detail referring to the drawings, wherein like reference numerals designate identical or corresponding parts throughout the several views.

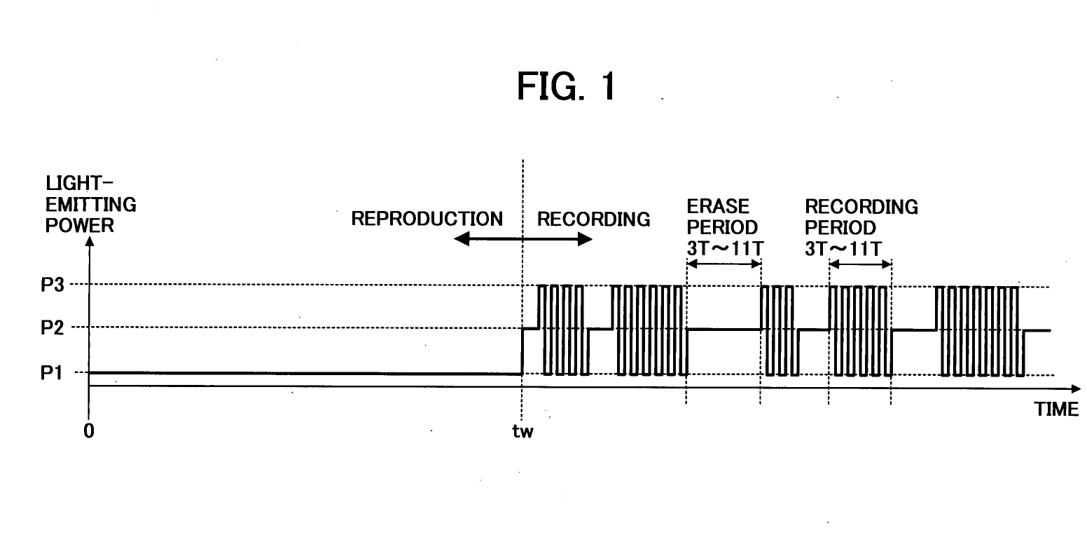

First, a basic technique of the present invention will be described. FIG. 1 is a diagram for explaining a laser light beam emitted from a laser light source to a CD-RW disk in an optical information recording and reproducing apparatus.

When recording information data into an optical recording medium, for example, into a CD-R disk, in an optical information recording and reproducing apparatus, a laser beam of high power intensity is emitted from a laser diode (hereafter referred to as an “LD”) as a laser light source and is radiated to a recording film of the CD-R disk. Thereby, marks (pits) are formed on the CD-R disk by a thermo-reaction. When recording information data into a CD-RW disk, the phase of a recording film of the CD-RW disk is changed.

The information data recorded into the optical recording medium is read out based on an amount of reflected light obtained by irradiating the recording film of the optical recording medium with a laser beam of low power intensity emitted from the LD. Generally, to change the phase of a recording film of a CD-RW disk, a laser light beam is emitted from an LD in a manner shown in FIG. 1. In FIG. 1, a period from a time “0” to a time “tw” represents a reproduction state, and a time elapsed since the time “tw” represents a state after the start of recording. As shown in FIG. 1, a laser light beam of first power intensity P1 is emitted in the reproduction state. The light-emitting power of the laser light beam of the first power intensity P1 is low, for example, about 1 mW.

In this embodiment, the first power intensity P1 is kept equal in the reproduction state and the state after the start of recording. However, the first power intensity P1 may be changed. After the start of recording, the recording film of the CD-RW disk is made amorphous by recording while emitting a laser light beam varied between third power intensity P3 and the first power intensity P1 at a high speed. Hereafter, a light-emitting period in which the recording film of the CD-RW disk is made amorphous will be referred to as a “recording period”. Further, the recording film of the CD-RW disk is made crystalline by recording while emitting a laser light beam of second power intensity P2 continuously. In this case, the second power intensity P2 of the laser light beam functions as a DC erase power. Generally, the light-emitting power of the laser light beam of the second power intensity P2 is, for example, about 10 mW, when the light-emitting power of the laser light beam of the first power intensity P1 is about 1 mW. Hereafter, a light-emitting period in which the recording film of the CD-RW disk is made crystalline will be referred to as an “erase period”.

As described above, the weak laser light beam of the first power intensity P1 is emitted in the reproduction state. The light radiated to amorphous portions of the recording film is not reflected. This condition is similar to a case in which marks (pits) are formed on a CD-R disk. On the other hand, when the weak laser light beam of the first power intensity P1 is radiated to crystalline portions of the recording film, the light is reflected back. This condition is similar to a case in which marks (pits) are not formed on a CD-R disk. In the erase period, when the laser light beam of the second power intensity P2 (e.g., the laser light beam of the DC erase power) is radiated to crystalline portions of the recording film, the crystalline portions of the recording film are kept crystalline. On the other hand, when the laser light beam of the second power intensity P2 (e.g., the laser light beam of the DC erase power) is radiated to amorphous portions of the recording film, the amorphous portions of the recording film are changed to crystalline portions.

Each of the recording period and the erase period has a time length in a range of 3T to 11T according to speed. In the recording period, as described above, emissions of laser light beams of the third power intensity P3 and the first power intensity P1 are repeated at a high speed. Generally, a period of emitting a laser light beam of the third power intensity P3 and a period of emitting a laser light beam of the first power intensity P1 are preset for each optical disk. In addition, a power intensity value between the second power intensity P2 and the first power intensity P1 and a power intensity value between the third power intensity P3 and the first power intensity P1 are preset for each optical disk.

Recently, a recording speed has been increasing. For example, a recording speed of a CD-RW disk is 16 times speed (16×). Generally, the light-emitting power of the laser light beam of the first power intensity P1 is in a range of about 1 mW to about 2 mW. The light-emitting power of the laser light beam of the second power intensity P2 is in a range of about 5 mW to about 20 mW. The light-emitting power of the laser light beam of the third power intensity P3 is in a range of about 10 mW to about 40 mW. Generally, in a CD-RW disk, a laser light beam varied between two different power intensity values is emitted in the recording period, and a laser light beam of one power intensity value is emitted in the erase period as described above. The light-emitting power of an LD typically varies due to a temperature rise caused by its oscillation. In particular, if the light-emitting power of an LD is high, the temperature of the LD rises in a short period of time as compared to a low light-emitting power. Therefore, it is necessary to keep a light-emitting power of an LD at a constant value by controlling a current for driving the LD while monitoring the output of the LD with a light-receiving element in an optical information recording and reproducing apparatus.

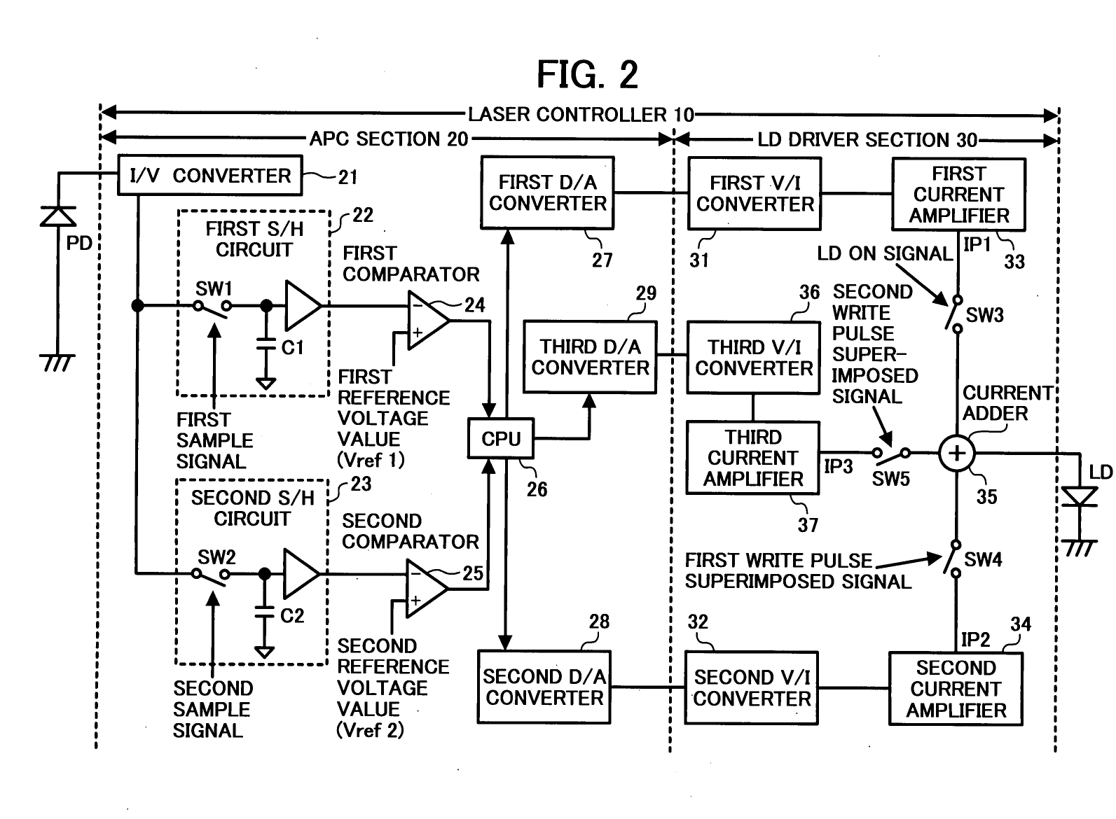

FIG. 2 is a block diagram of a circuit of a laser controller that performs a constant power control of a light beam emission to a CD-RW disk. In FIG. 2, a photodiode (PD) is a light-receiving element. The light incident on the PD is converted to a current in proportion to an intensity of the light by a photoelectric conversion. The PD monitors a part of a laser light beam emitted from the LD, and a large amount of the emitted laser light beam is radiated to a recording film of the CD-RW disk. In this embodiment, the PD functions as a light-emitting power detecting mechanism that detects a light-emitting power of a laser light beam emitted from the LD. Next, an I/V converter 21 converts the current value output from the PD to a voltage value.

With respect to voltage values output from the I/V converter 21, a voltage value obtained by converting a current value corresponding to the laser light beam of the first power intensity P1 at the time of reproduction is set as a voltage value V(P1), and a voltage value obtained by converting a current value corresponding to the laser light beam of the second power intensity P2 in the erase period at the time of recording is set as a voltage value V(P2).

A laser controller 10 includes a first sample-hold (S/H) circuit 22 that samples and holds the voltage value V(P1) at the time of reproduction, and a second sample-hold (S/H) circuit 23 that samples and holds the voltage value V(P2) in the erase period at the time of recording. The reason why two sample-hold circuits are provided is as follows. Because there is a power difference between the laser light beam of the first power intensity P1 and the laser light beam of the second power intensity P2, if a common sample-hold circuit samples and holds the voltage value V(P1) and the voltage value V(P2), the sampled and held voltage value V(P1) becomes substantially small. Therefore, in the first sample-hold (S/H) circuit 22, the sampled and held voltage value V(P1) is amplified with a predetermined gain which is different from a gain used for amplifying the sampled and held voltage value V(P2) in the second sample-hold (S/H) circuit 23.

Generally, an optical information recording and reproducing apparatus is configured to record information data into not only a CD-RW disk but also a CD-R disk. In the case of recording information data into the CD-R disk, two sample-hold (S/H) circuits are used for sampling and holding not only the voltage value V(P2) but also the voltage value V(P1) after the start of recording. A detail description of the CD-R disk will be omitted here.

As described above, the first sample-hold (S/H) circuit 22 samples the voltage value V(P1) at the time of reproduction. At the time of reproduction, a first sample signal in the first sample-hold (S/H) circuit 22 constantly turns on a switch (SW1) in the first sample-hold (S/H) circuit 22. Further, the first sample signal constantly turns off the switch (SW1) during the recording period after the start of recording information data into the CD-RW disk. Because a laser light beam of the third power intensity P3 and a laser light beam of the first power intensity P1 are emitted alternately at a high speed during the recording period, the period of the emission of the laser light beam of the first power intensity P1 is too short. Therefore, the first sample-hold (S/H) circuit 22 cannot sample and hold the voltage value V(P1) in the recording period.

A second sample signal in the second sample-hold (S/H) circuit 23 constantly turns off a switch (SW2) in the second sample-hold (S/H) circuit 23 at the time of reproduction. After the start of recording, the switch (SW2) in the second sample-hold (S/H) circuit 23 is turned on in the erase period (e.g., the period in which the laser light beam of the second power intensity P2 is emitted) or in a period shorter than the erase period. In the recording period, the switch (SW2) in the second sample-hold (S/H) circuit 23 is turned off. Thus, the second sample signal is a control signal for taking out only a voltage value Vs(P2) corresponding to the laser light beam of the second power intensity P2 in a condenser C2 in the second sample-hold (S/H) circuit 23.

A voltage value Vs(P1) output from the first sample-hold (S/H) circuit 22 at the time of reproduction, and the voltage value Vs(P2) output from the second sample-hold (S/H) circuit 23 after the start of recording, are input to a first comparator 24 and a second comparator 25, respectively. The first comparator 24 compares the voltage value Vs(P1) with a first reference voltage value (Vref1), and the second comparator 25 compares the voltage value Vs(P2) with a second reference voltage value (Vref2). Each of the first comparator 24 and the second comparator 25 determines if a value of an input signal exceeds a reference voltage value, and outputs signals of a comparison result, that is, binary signals (digital data). Subsequently, a central processing unit (CPU) 26 reads the digital data.

Then, the digital data is transmitted from the CPU 26 to a first D/A converter 27 that converts a digital value to an analog value. The first D/A converter 27 outputs a voltage value in proportion to the digital data input thereto to a first V/I converter 31. Further, the first V/I converter 31 outputs a current value according to the voltage value output from the first D/A converter 27. Likewise, digital data is transmitted from the CPU 26 to a second D/A converter 28. The second D/A converter 28 outputs a voltage value in proportion to the digital data input thereto to a second V/I converter 32. Further, the second V/I converter 32 outputs a current value according to the voltage value output from the second D/A converter 28.

Further, current values output from the first V/I converter 31 and the second V/I converter 32 are amplified by a first current amplifier 33 and a second current amplifier 34, respectively. At the time of reproduction, the output current of the first current amplifier 33 is supplied to an LD by turning on a switch SW3 by a light source on signal (LD ON signal), and thereby the LD emits a laser light beam of the first power intensity P1. After the start of recording, the output current of the second current amplifier 34 is added to the output current of the first current amplifier 33 by a current adder 35 by turning on a switch SW4 by a first write pulse superimposed signal, and is supplied to the LD. Then, the LD emits a laser light beam of the second power intensity P2. Here, a current value output from the first current amplifier 33 is referred to as “IP1”, and a current value output from the second current amplifier 34 is referred to as “IP2”.

The laser controller 10 keeps the light-emitting power of the LD at a constant level in a manner described below.

First, at the time of start of reproduction, the CPU 26 outputs “0” to the first D/A converter 27. Thereby, a current value for a reproduction power of the LD starts from “0”. Then, the CPU 26 gradually increases data to be output to the first D/A converter 27 until the output of the first comparator 24 is inversed, that is, until the voltage value Vs(P1) exceeds the first reference voltage value Vref1. Subsequently, the data output from the CPU 26 to the first D/A converter 27 is adjusted such that the voltage value Vs(P1) becomes close to the first reference voltage value Vref1.

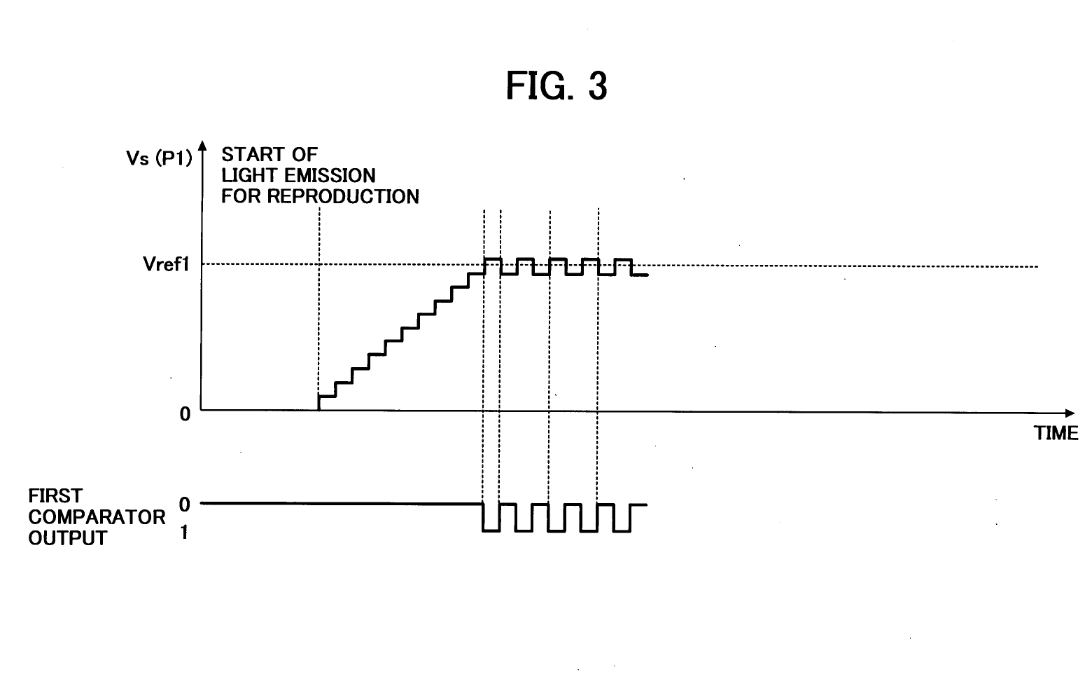

FIG. 3 is a time chart showing a relation between the voltage value Vs(P1) output from the first sample-hold (S/H) circuit 22 and an output of the first comparator 24 in a digital control. As shown in FIG. 3, the reproduction power of the LD is kept at a constant level by performing the above-described digital control. As an ideal condition, it is preferable that the voltage value Vs(P1) becomes equal to the first reference voltage value Vref1. However, in reality, the voltage value Vs(P1) exceeds and falls below the first reference voltage value Vref1 as shown in FIG. 3.

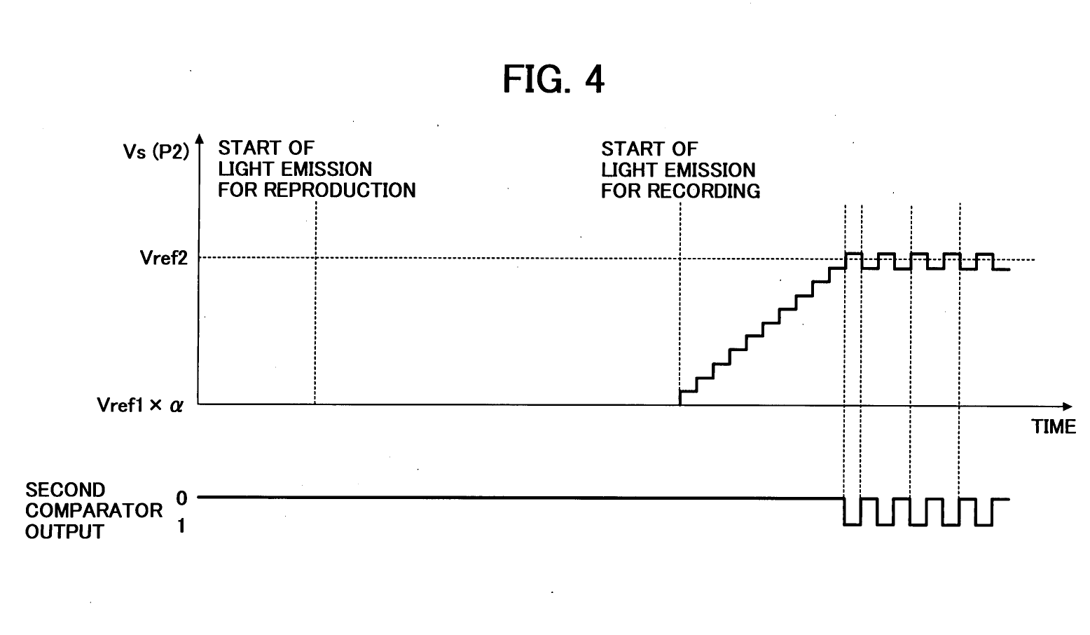

FIG. 4 is a time chart showing a relation between the voltage value Vs(P2) output from the second sample-hold (S/H) circuit 23 and an output of the second comparator 25 in a digital control. Specifically, FIG. 4 shows a state in which the laser light beam of the first power intensity P1 emitted from the LD at the time of reproduction changes to the laser light beam of the second power intensity P2 and is kept at a constant level after the start of recording. In FIG. 4, the CPU 26 sets the output of the second D/A converter 28 at “0” at the time of a light emission for reproduction. The voltage value Vs(P2) output from the second sample-hold (S/H) circuit 23 just after the start of recording is substantially equal to the voltage value Vs(P1) output from the first sample-hold (S/H) circuit 22 at the time of reproduction. As shown in FIG. 4, the first reference voltage value Vref1 is multiplied by “α” as a difference of gain in the path. Generally, the value of “α” is set to be less than “1”.

Then, the CPU 26 increases data to be output to the second D/A converter 28 by “1” or a predetermined value. The current value according to the voltage value output from the second D/A converter 28 is superimposed on the current value according to the voltage value output from the first D/A converter 27 as a current value for an erase power of the LD. Accordingly, the voltage value Vs(P2) output from the second sample-hold (S/H) circuit 23, which are obtained by monitoring, sampling, and holding the current value for the erase power of the LD, increases by a predetermined amount such that the voltage value Vs(P2) becomes close to the second reference voltage value Vref2 as shown in FIG. 4. Subsequently, as shown in FIG. 4, the erase power of the LD is kept at a constant level as was done similarly at the time of reproduction. As an ideal condition, it is preferable that the voltage value Vs(P2) becomes equal to the second reference voltage value Vref2. However, in reality, the voltage value Vs(P2) exceeds and falls below the second reference voltage value Vref2 as shown in FIG. 4.

As described above, the voltage of the laser light beam of the first power intensity P1 is not sampled and held after the start of recording. The output value of the first D/A converter 27 at the start of recording may be set to the output value of the first D/A converter 27 just before the start of recording. Specifically, the laser light beam of the first power intensity P1 has a low light-emitting power, and the LD emits the laser light beam of the first power intensity P1 only in the recording period after the start of recording. The laser light beam of the first power intensity P1 is intermittently emitted from the LD, and is not influenced much by the variation of the light emission of the LD caused by its temperature. Therefore, the output value of the first D/A converter 27 may be set to a constant value. Thus, the laser light beam of the first power intensity P1 may be emitted from the LD at a constant level in the recording period after the start of recording.

In the above-described circuit of the laser controller 10, a digital control is performed by using the CPU 26 and the D/A converters at the time of reproduction and recording. In place of the digital control, an analog control may be employed to perform a constant power control. For example, in the analog control, a signal output from a first sample-hold (S/H) circuit or a signal output from a second sample-hold (S/H) circuit is input to an error amplifier, such as, an integrator. In the error amplifier, a value of the signal is compared with a reference voltage value. If the value of the signal is different from the reference voltage value, the error amplifier outputs a voltage value for adjusting the difference between the value of the signal and the reference voltage value to a first V/I converter or a second V/I converter.

Because the laser light beam of the first power intensity P1 has a low light-emitting power, even though the analog control is performed, the voltage value output from the error amplifier does not vary significantly just after the start of reproduction. Further, in the analog control, a period of time necessary for making the light-emitting power constant is shorter than that in the digital control. For these reasons, the laser light beam of the first power intensity P1 is often controlled by the analog control at the time of reproduction.

When controlling the laser light beam of the first power intensity P1 by the analog control, a signal output from the first sample-hold (S/H) circuit is input to the error amplifier. Then, a voltage value output from the error amplifier is directly input to the first V/I converter. In addition, it is configured such that the voltage value output from the first D/A converter is input to the first V/I converter. A switch may be provided to switch the input to the first V/I converter either from the error amplifier or from the first D/A converter. Further, it may be configured such that an A/D converter may check the output level of the error amplifier when the emitting power of the laser light beam of the first power intensity P1 is made at a constant level at the time of reproduction. After the start of recording, a voltage value output from the first D/A converter in the digital control is made equal to the voltage value output from the error amplifier in the analog control.

Thus, a laser power control operation is similarly performed in both the analog control and the digital control. Specifically, the light-emitting power of the LD is monitored. Then, a voltage value corresponding to a laser light beam of a predetermined intensity is compared with a reference voltage value. Then, a drive current value to be input to the LD is controlled such that the voltage value corresponding to the laser light beam of the predetermined intensity becomes close to (ideally, equal to) the reference voltage value.

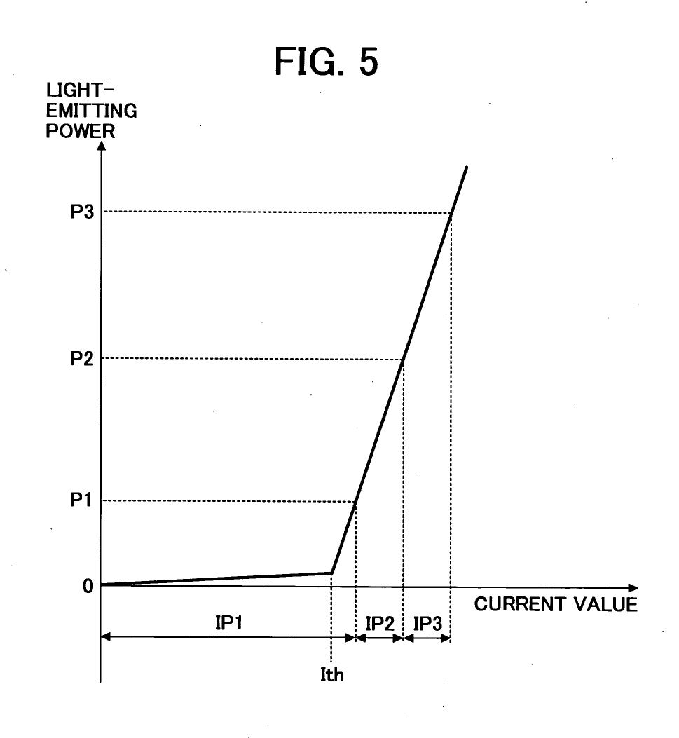

FIG. 5 is a characteristic diagram showing a relation between a current value for driving the LD and the light-emitting power of the LD. As shown in FIG. 5, there is a linear functional relation between the current value for driving the LD and the light-emitting power of the LD when the current value exceeds a threshold value “Ith”. The slope of the line segment may vary depending on an LD. Because the light-emitting power of the LD has a specific relation relative to the current value for driving the LD, the light-emitting power of the LD also has a specific relation relative to the voltage value set at the D/A converter for setting the current value for driving the LD. Further, because the voltage value set at the D/A converter for setting the current value for driving the LD is determined based on the reference voltage value of the comparator, there is a linear functional relation between the reference voltage value of the comparator and the light-emitting power of the LD with a predetermined slope.

Therefore, if the slope is calculated in advance, the light-emitting power of the LD is obtained from the reference voltage value. If a slope or an intercept of the line is stored in a memory, the light-emitting power of the LD is controlled efficiently. Usually, the relation between the reference voltage value of the comparator and the first power intensity P1 or the second power intensity P2 is obtained in advance, for example, as a relational expression in a production process of an optical information recording and reproducing apparatus. When emitting a laser light beam from an LD in an actual operation of the optical information recording and reproducing apparatus, the first power intensity P1 and the second power intensity P2 are set by the relational expression.

Although the above-described slope of the line segment varies depending on characteristics of an LD, such as a temperature, and the threshold value “Ith” shifts, the CPU 26 controls the light-emitting power of the LD at a constant level by adjusting a current value for driving the LD (e.g., a current value output from the V/I converter) such that the voltage value output from the sample-hold (S/H) circuit becomes close to the reference voltage value of the comparator.

Generally, a control for keeping a light-emitting power of an LD at a constant level is referred to as an auto power control (APC). As described above, after the start of recording information data into the CD-RW disk, because the laser light beam of the first power intensity P1 has a low light-emitting power, and is intermittently emitted from the LD, the laser light beam of the first power intensity P1 is not sampled and held, so that the laser light beam of the first power intensity P1 emitted after the start of recording is not subjected to the APC. Only the laser light beam of the second power intensity P2 (e.g., an erase power) is subjected to the APC after the start of recording.

Next, a control for an emission of a laser light beam of the third power intensity P3 will be described.

As described above, when recording information data into and reproducing information data from a CD-RW disk, three different intensity values of light-emitting power (power levels) are used, that is, the first power intensity P1, the second power intensity P2, and the third power intensity P3. When emitting the laser light beam of the third power intensity P3 from the LD, an output current of a third current amplifier 37 is added to the output current of the first current amplifier 33 and the output current of the second current amplifier 34 by the current adder 35 by turning on a switch SW5 by a second write pulse superimposed signal, and is supplied to the LD. Then, the LD emits a laser light beam of the third power intensity P3. Here, a current value output from the third current amplifier 37 is referred to as “IP3”.

In FIG. 5, a first current value required to be supplied to the LD for emitting a laser light beam at a power level of the first power intensity P1 is indicated by “IP1”, a second current value required to be supplied to the LD for emitting a laser light beam at a power level of the second power intensity P2 is indicated by “IP2”, and a third current value required to be supplied to the LD for emitting a laser light beam at a power level of the third power intensity P3 is indicated by “IP3”. Specifically, when supplying a current value (IP1) to the LD, the LD emits the laser light beam of the first power intensity P1. When supplying a current value (IP1+IP2) to the LD, the LD emits the laser light beam of the second power intensity P2. When supplying a current value (IP1+IP2+IP3) to the LD, the LD emits the laser light beam of the third power intensity P3.

The second power intensity P2 is controlled such that the voltage value input to the second comparator 25 becomes close to or, ideally, equal to the second reference voltage value Vref2 by changing the second current value IP2 (e.g., the voltage value set at the second D/A converter 28) by the APC. As provided similarly in connection with the laser light beam of the first power intensity P1, the laser light beam of the third power intensity P3 is intermittently emitted from the LD only in the recording period after the start of recording. Therefore, it is difficult to sample and hold the laser light beam of the third power intensity P3. For this reason, a voltage value set at a third D/A converter 29 is input to a third V/I converter 36. Then, the output current of the third V/I converter 36 becomes the third current value IP3.

The third power intensity P3 has a substantially greater power than the first power intensity P1. For example, the third power intensity P3 may have about double the power of the second power intensity P2. When emitting the laser light beam of the third power intensity P3 from the LD, the output of the LD varies due to the increase of the temperature of the LD. In this condition, even if the third current value IP3 for driving the LD is unchanged, the third power intensity P3 of the laser light beam emitted from the LD changes. For these reasons, the laser light beam of the third power intensity P3 needs to be controlled. The power level of the third power intensity P3 is maintained by changing the third current value IP3 in the following manner.

As shown in FIG. 5, there is a linear functional relation between the current value for driving the LD and the light-emitting power of the LD. Assuming that the slope of the line is constant when the current value exceeds the threshold value “Ith”, the slope obtained from the second current value IP2 and the second power intensity P2 may be considered as a laser efficiency value, that is, a ratio between the current value and the light-emitting power. The laser efficiency value (i.e., the slope) is unchanged unless the light-emitting power of the LD is close to an upper limit. In the case of recording data into the CD-RW disk, the light-emitting power of an LD does not generally approach the upper limit. Specifically, the third current value IP3 is determined as follows.

First, a laser efficiency value EV1 is obtained by the following equation,
EV1=(P2−P1)/IP2 (1)
where P2 is the second power intensity, P1 is the first power intensity, and IP2 is the second current value.

The laser efficiency value EV1 is obtained by the above equation because the current value for driving the LD and the light-emitting power of the LD are directly proportional when the current value exceeds the threshold value “Ith” as shown in FIG. 5.

Next, the third current value IP3 required to be supplied to the LD to emit a laser light beam at a power level of the third power intensity P3 is determined by the following equation,
IP3=(P3−P2)/EV1 (2)
where P3 is the third power intensity, P2 is the second power intensity, and EV1 is the laser efficiency value obtained by equation (1).

As described above, the first power intensity P1, the second power intensity P2, and the third power intensity P3 are preset as target power intensity values. On the other hand, the second current value IP2 varies by being subjected to the automatic power control (APC). The value of the third power intensity P3 is maintained by adjusting the third current value IP3 based on the varied second current value IP2.

Before recording information data into an optical disk, a so-called optimum power control (OPC) needs to be performed to determine an optimum intensity value of a recording power of a laser light beam. Such an OPC needs to be performed because an optimum intensity value of a recording power of a laser light beam varies depending on factors, such as a recording sensitivity of an optical disk, a laser wavelength, a recording wavelength, and a temperature.

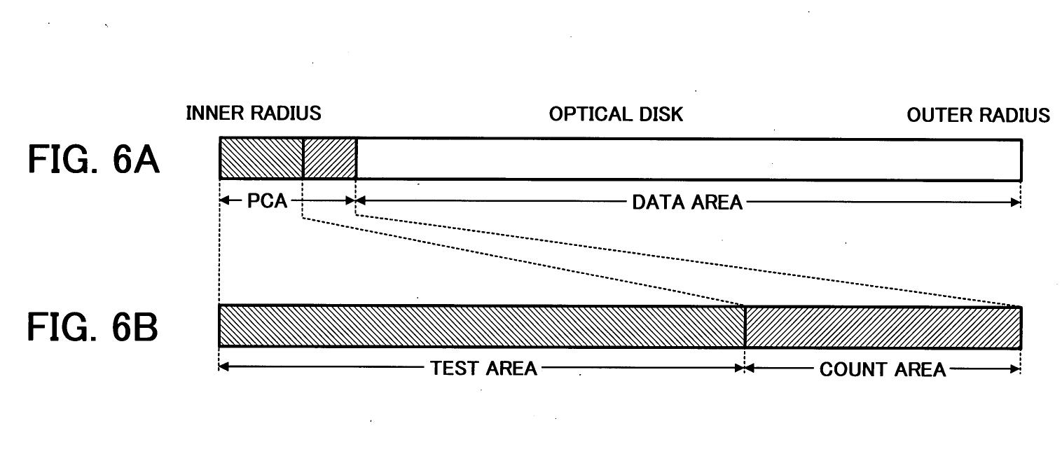

FIG. 6A is a diagram showing a cross section taken along a radial direction of an optical disk. FIG. 6B is a diagram showing a test area and a count area in a power calibration area. As shown in FIG. 6A, the optical disk includes a power calibration area (PCA) where the OPC is performed, and a data area. The PCA is a test recording area used for determining an optimum intensity value of a recording power of a laser light beam. The data area is used for recording various data. The power calibration area is located on the inner radius side, and includes a test area and a count area as shown in FIG. 6B. The test area includes 100 partitions. Each of these partitions includes 15 frames. A frame is a minimum unit of the recording area on the optical disk.

When performing the OPC, a non-recorded partition in the test area is searched. Test data i s recorded on 15 frames of the partition by variously changing an intensity value of a recording power of a laser light beam step by step from a minimum intensity value to a maximum intensity value (e.g., up to 15 intensity values). The intensity value of the recording power of the laser light beam that provides a highest recording quality is detected by reproducing the recorded test data, and is determined to be an optimum intensity value of a recording power of a laser light beam.

The count area includes 100 partitions. Each of these partitions includes one frame. Each partition in the count area corresponds to a respective partition in the test area. When a partition in the test area is used, data is recorded in the corresponding partition in the count area and is used for searching a test recording start position of the test area.

In a method of calculating a peak power (e.g., the third power intensity P3) from an erase power (e.g., the second power intensity P2), if a signal output from a PD has a high noise and fluctuations, the signal sampled and held by a sample-hold circuit also has a noise and fluctuations. In this condition, the voltage value input to a comparator has various levels. As a result, the second current value IP2 may be set to, for example, three values or four values even though the temperature of the LD does not vary. Further, the third power intensity P3 is determined from the three values or four values of the second power intensity P2. As the third power intensity P3 as a peak power is greater than the second power intensity P2 as an erase power by about two times, fluctuations of the emitted laser light beam of the third power intensity P3 increase two fold. The fluctuations of the peak power directly exert a negative in fluence on recording quality.

In the OPC according to the embodiment of the present invention, test data is recorded on 15 frames of the partition of the test area by variously changing respective intensity values of the laser light beam of the third power intensity P3 and the laser light beam of the second power intensity P2. The emitted laser light beam of the second power intensity P2 is subjected to the APC in each frame of the partition of the test area and is controlled at a constant level in the APC. In the OPC, a period for recording test data on the test area with respective predetermined intensity values of the laser light beam of the third power intensity P3 and the laser light beam of the second power intensity P2 is very short as compared to a case in which actual information data is recorded on the data area. For example, immediately after the laser light beam of the second power intensity P2 is subjected to the APC and its power intensity value becomes constant in one of 15 frames of a partition of the test area, test data is recorded on another frame of the partition of the test area with respective changed intensity values of the laser light beam of the third power intensity P3 and the laser light beam of the second power intensity P2.

As described above, in the laser controller 10 of the present embodiment, if the second current value IP2 fluctuates, the third current value IP3 fluctuates accordingly. Further, if the second power intensity P2 fluctuates between, for example, three values or four values, the third power intensity P3 also fluctuates between three values or four values. If the above-described OPC is performed in the condition that the laser light beam of the third power intensity P3 and the laser light beam of the second power intensity P2 fluctuate, an optimum intensity value of a recording power of a laser light beam cannot be adequately determined. Further, in this condition, if the OPC is performed in the same optical disk under the same condition (e.g., a recording speed), an optimum intensity value of a recording power determined by the OPC varies. Therefore, in the optical information recording and reproducing apparatus according to the embodiment of the present invention, the light-emitting power of the laser light beam emitted from the LD needs to be prevented from fluctuating to determine an optimum intensity value of a recording power in an OPC operation for a CD-RW disk.

As shown in FIG. 2, the circuit of the laser controller 10 is divided into two sections, that is, an auto power control (APC) section 20 and an LD driver section 30. The LD driver section 30 functions as a laser diode drive mechanism that drives the LD by supplying current to the LD. The APC section 20 functions as a power intensity adjusting mechanism that adjusts a power intensity of a laser light beam emitted from the LD based on a light-emitting power of a laser light beam detected by the PD by changing a value of the current supplied to the LD by the LD driver section 30.

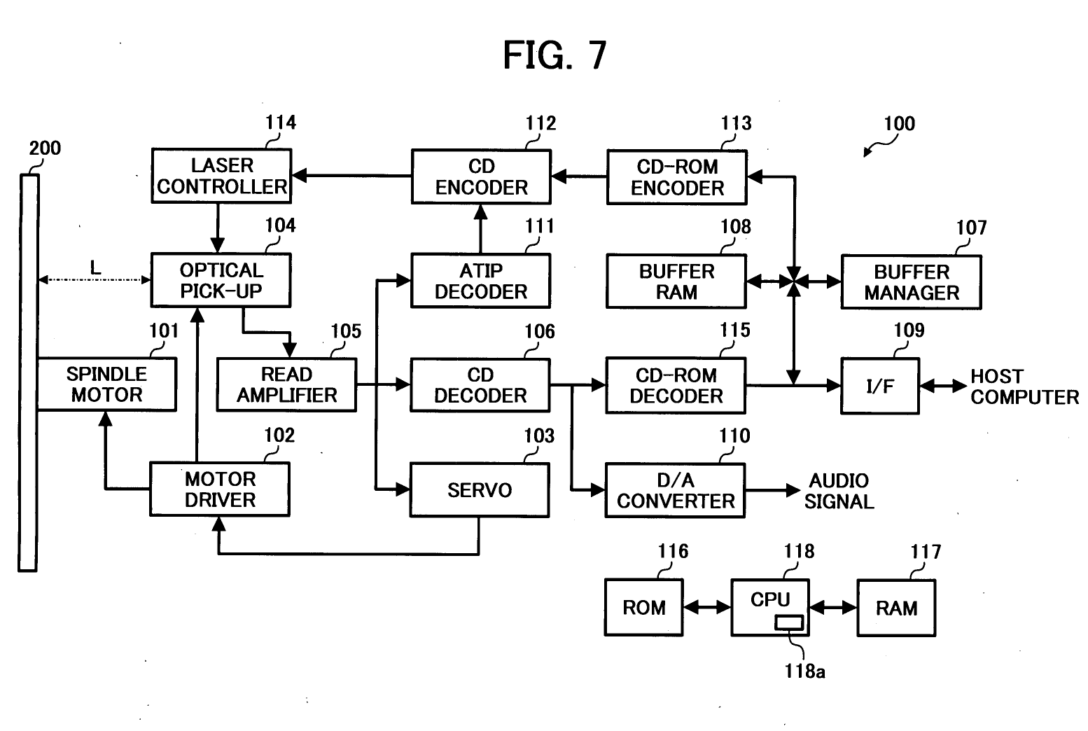

FIG. 7 is a block diagram of a configuration of an optical information recording and reproducing apparatus according to an embodiment of the present invention. As a non-limiting example of an optical information recording and reproducing apparatus, a description will be made of a CD-RW drive that records and reproduces information data into and from a CD-RW (CD rewritable) disk. The CD-RW disk is a recordable compact disk, into which information data can be recorded a plurality of times.

The optical information recording and reproducing apparatus 100 includes a spindle motor 101, a motor driver 102, a servo 103, an optical pick-up 104, a read amplifier 105, a CD decoder 106, a buffer manager 107, a buffer RAM 108, an interface (I/F) 109 such as an ATAPI/SCSI, a D/A converter 110, an ATIP decoder 111, a CD encoder 112, a CD-ROM encoder 113, a laser controller 114, a CD-ROM decoder 115, a ROM 116, a RAM 117, and a CPU 118 including a register 118a. A reference symbol “L” in FIG. 7 indicates a laser light beam. In this embodiment, the laser controller 114 corresponds to the laser controller 10 of FIG. 2 and performs a method of determining a value of current supplied to a laser light source of the present invention (described below) in accordance with the instruction of the CPU 118. The control signals at the respective switches in the laser controller 10 of FIG. 2, such as the first sample signal, the second sample signal, the LD ON signal, the first write pulse superimposed signal, and the second write pulse superimposed signal, are output from the CD encoder 112. In FIG. 7, arrows indicate the direction of data flow. To simplify the diagram, a detailed connection relation between the CPU 118 and each block controlled by the CPU 118 is not shown in FIG. 7.

Next, an operation of the optical information recording and reproducing apparatus 100 is now described. An optical disk 200, such as a CD-RW disk, is rotated by the spindle motor 101. The spindle motor 101 is controlled, by the motor driver 102 and the servo 103, such that the optical disk 200 rotates at a constant velocity. The optical pick-up 104 includes an LD, an optical system such as lens, a focus actuator, a track actuator, a photo detector, and a position sensor (all of which are not shown). The focus actuator is configured to move the position of an objective lens in a direction orthogonal to a surface of the optical disk 200 such that a laser light beam comes into a focus on the optical disk 200. The track actuator is configured to move the objective lens in a sledge direction (i.e., a radial direction of the optical disk 200) such that a focal point of a laser light beam traces track grooves. The optical pick-up 104 emits a laser light beam “L” to the recording surface of the optical disk 200. The optical pick-up 104 is configured to be moved along a sledge direction by a seek motor (not shown). The focus actuator, the track actuator, and the seek motor are controlled to locate a light spot of the laser light beam “L” at a desired position on the optical disk 200 by using the motor driver 102 and the servo 103 based on signals from the photo detector and the position sensor of the optical pick-up 104.

When reproducing data, a reproducing signal obtained from the optical pick-up 104 is amplified by the read amplifier 105 to convert into binary data. The binary data is input to the CD decoder 106, where de-interleave and error correction are carried out. The CD decoder 106 performs an Eight to Fourteen bit Modulation (EFM) to decode the binary data into decoded data. Recorded data in the optical disk 200 are modulated in EFM that is summed up 8 bits at a time. It is converted 8 bits to 14 bits and then to 17 bits by adding 3 coupling bits in an EFM process.

Decoded data is de-interleaved and error-corrected. Subsequently, the data is input to the CD-ROM decoder 115 and subjected to an additional error-correction to improve data reliability. Then, the data is stored in the buffer RAM 108 once by the buffer manager 107. If the stored data gets into sector datum, the sector datum is transferred to a host computer through the interface 109 as a sector datum unit. In the case of audio data, data output from the CD decoder 106 is input to the D/A converter 110 and is output as analog audio output signals.

When recording data, data is transferred from the host computer to the optical information recording and reproducing apparatus through the interface 109 and the data is stored in the buffer RAM 108 once by the buffer manager 107. A writing process is started by storing a certain level of data in the buffer RAM 108. Before writing data on the optical disk 200, the laser spot needs to be set in a write start position. This position is searched with a wobble signal formed on the optical disk 200 as track grooves.

The wobble signal contains information on absolute time referred to as Absolute Time In Pre-groove (ATIP) The information on absolute time is obtained from the ATIP decoder 111. A synchronization signal generated by the ATIP decoder 111 is input to the CD encoder 112, and this signal makes it possible to write data into an accurate position on the optical disk 200. Error-correction codes are added to the data in the buffer RAM 108, and the data is interleaved in the CD-ROM encoder 113 and the CD encoder 112, before data is written in the optical disk 200 through the laser controller 114 and the optical pick-up 104.

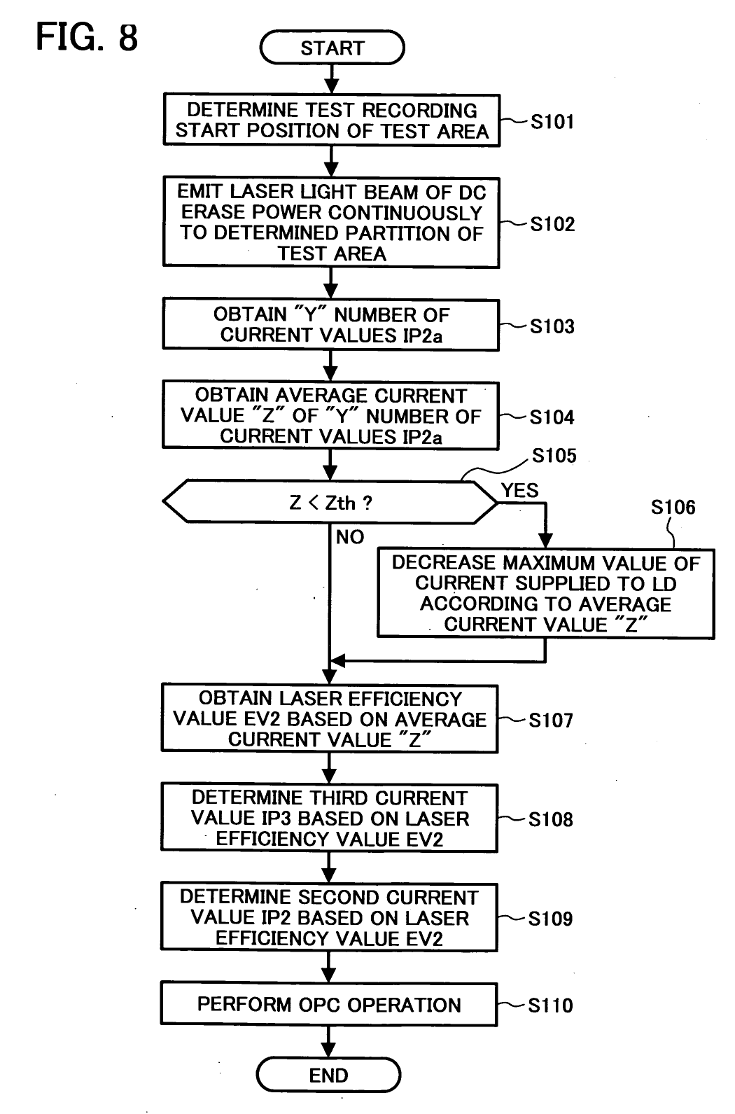

Next, an operation for determining a value of current supplied to a laser light source (hereafter referred to as a “current value determining operation”) performed by the CPU 118 in the optical information recording and reproducing apparatus will be described referring to FIG. 8. FIG. 8 is a flowchart of current value determining operation steps of the CPU 118 according to the embodiment of the present invention. First, the CPU 118 determines a test recording start position of a test area of a power calibration area (PCA) where an OPC operation is to be performed by analyzing a count area of the PCA in step S101. As described above, when a partition in a test area is used in an OPC operation, data is recorded in the corresponding partition in a count area and is used for searching a test recording start position of the test area.

Then, in step S102, the CPU 118 causes the LD to emit a laser light beam of predetermined power intensity (hereafter referred to as a “DC erase power”) continuously to the determined partition of the test area at a constant power intensity value before performing the OPC operation. If the intensity of the DC erase power is too high, a characteristic of an optical disk typically changes. Consequently, a recording operation and an erase operation may not be performed properly relative to the optical disk. If the intensity of the DC erase power is too low, there is a substantial difference between the intensity of a recording power in an OPC operation and the intensity of the DC erase power. Consequently, the temperature of the LD when emitting the laser light beam of the DC erase power is substantially different from the temperature of the LD in an OPC operation, so that the laser efficiency value of the LD obtained when emitting the laser light beam of the DC erase power (described below) may be different from the laser efficiency value of the LD in the OPC operation. For these reasons, the intensity of the DC erase power is preferably set to be greater than the first power intensity (P1) and less than the third power intensity (P3). As a non-limiting example, the LD emits the laser light beam of the DC erase power when supplying a current value (IP1+IP2a) to the LD. The current value IP2a (i.e., the voltage value set at the second D/A converter 28) is the output current of the second current amplifier 34, and is added to the first current value IP1 which is the output current of the first current amplifier 33.

Next, in step S103, during a period in which the laser light beam of the DC erase power is continuously emitted to the determined partition of the test area at a constant power intensity value, a plurality of (for example, “Y” number) current values IP2a supplied to the LD are obtained as sample values based on the instruction of the CPU 118 to the D/A converter 28. Particularly, the “Y” number of current values IP2a are all stabilized current values IP2a, and do not include a “X” number of non-stabilized current values IP2a supplied to the LD immediately after the start of emission of the laser light beam of the DC erase power from the LD. Such a “X” number of non-stabilized current values IP2a is preferably preset based on results of experiments. By excluding the “X” number of non-stabilized current values IP2a supplied to the LD immediately after the start of emission of the laser light beam of the DC erase power from the LD, a laser efficiency value of the LD (described below) can be obtained with accuracy. The “Y” number of the current values IP2a obtained by the CPU 118 are stored in the register 118a.

Subsequently, in step S104, the CPU 118 obtains an average current value “Z” of the “Y” number of the current values IP2a obtained in step S103. If the “Y” number of current values IP2a obtained in step S103 is relatively great, an overflow error typically occurs. Consequently, the average current value “Z” of the “Y” number of the current values IP2a may not be obtained properly. If the “Y” number of current values IP2a is relatively small, fluctuations of the current values IP2a may not be leveled out properly.

Next, in step S105, the CPU 118 determines whether the average current value “Z” is less than a threshold value “Zth”. If the answer is YES in step S105, the CPU 118 decreases a maximum value of current supplied to the LD according to the average current value “Z” in step S106. For example, assuming that the DC erase power of the laser light beam is 10 mW, the value of the second D/A converter 28 set by the CPU 118 for outputting the current value IP2a is set to 100 Least Significant Bits (LSB). Further, in a subsequent OPC operation and a recording period after the OPC operation, the value of the third D/A converter 29 set by the CPU 118 for outputting the current value IP3 is assumed to be at most 200 LSB based on design calculation and experimental results so long as the LD is not deteriorated.

If the maximum value of the third D/A converter 29 set for outputting the current value IP3 is 400 LSB and if the maximum value of current (IP3) supplied to the LD is 400 mA, the third D/A converter 29 has a ratio of 1 mA/LSB. However, as described above, because the value of the third D/A converter 29 set for outputting the current value IP3 is assumed to be at most 200 LSB (=200 mA), the maximum value of current (IP3) supplied to the LD can be reduced to 200 mA. Consequently, the third D/A converter 29 has a ratio of 200 mA/400 LSB, that is, 0.5 mA/LSB, and the resolution of the third D/A converter 29 can be enhanced (higher). At the same time, the maximum value of the first D/A converter 27 set for outputting the current value IP1 and the maximum value of the second D/A converter 28 set for outputting the current value IP2 are reduced equally. Thus, each resolution of the first D/A converter 27 and the second D/A converter 28 is similarly enhanced. By enhancing the resolution of the second D/A converter 28 and the resolution of the third D/A converter 29, each fluctuation amount (width of 1 LSB) of the second current value IP2 and the third current value IP3 can be reduced. Thus, a recording quality can be enhanced. The above-described threshold value “Zth” in step S105 is an assumed value of the current value IP2a calculated from the assumed current value IP3.

If the average current value “Z” is greater than or equal to the threshold value “Zth” (e.g., the answer is NO in step S105), the CPU 118 obtains a laser efficiency value EV2, that is, a ratio between a current value and a light-emitting power, by the following equation in step S107,
EV2=(Per−P1)/Z (3)
where Per is the DC erase power intensity, P1 is the first power intensity, and Z is the average current value of the “Y” number of the current values IP2a.

Further, the CPU 118 determines the third current value IP3 required to be supplied to the LD to emit a laser light beam at a power level of the third power intensity P3 in an OPC operation by the following equation in step S108,
IP3=(P3−P2)/EV2 (4)
where P3 is the third power intensity, P2 is the second power intensity, and EV2 is the laser efficiency value obtained by equation (3).

Further, the CPU 118 determines the second current value IP2 required to be supplied to the LD to emit a laser light beam at a power level of the second power intensity P2 at the start of recording test data in an OPC operation by the following equation in step S109,
IP2=(P2−P1)/EV2 (5)
where P2 is the second power intensity, P1 is the first power intensity, and EV2 is the laser efficiency value obtained by equation (3).

Subsequently, the CPU 118 performs an OPC operation by supplying the third current value IP3 determined by equation (4) and the second current value IP2 determined by equation (5) to the LD in step S110 and by variously changing respective intensity values of the laser light beam of the third power intensity P3 and the laser light beam of the second power intensity P2.

In the above-described current value determining operation, a plurality (i.e., “Y” number) of the current values IP2a are obtained during a period in which the LD emits a laser light beam of DC erase power continuously to the determined partition of the test area at a constant power intensity value before performing the OPC operation. Further, an average current value “Z” of the “Y” number of the current values IP2a is obtained, and thereby fluctuations of the current values IP2a can be leveled out properly. As compared to a case in which the third current value IP3 is determined based on the laser efficiency value EV1 obtained from the fluctuated second current value IP2 (see equations (1) and (2)), the third current value IP3, which is determined based on the laser efficiency value EV2 obtained from the average current value Z, is prevented from fluctuating significantly in the OPC operation. Therefore, in the optical information recording and reproducing apparatus according to the embodiment of the present invention, even if the second current value IP2 fluctuates in the OPC operation, fluctuations of a peak power (i.e., the third power intensity P3) are avoided in the OPC operation. As a result, a recording quality in the OPC operation is enhanced, and thereby an optimum intensity value of a recording power of a laser light beam is adequately determined.

In the above-described step S109, the CPU 118 determines the second current value IP2 required to be supplied to the LD to emit a laser light beam at a power level of the second power intensity P2 at the start of recording test data in an OPC operation by equation (5). In an OPC operation, respective intensity values of the laser light beam of the third power intensity P3 and the laser light beam of the second power intensity P2 are variously changed. As shown in FIG. 4, after the start of recording, the second power intensity P2 increases step by step, and it takes some time to keep the second power intensity P2 at a constant level after the start of recording. Therefore, by determining the second current value IP2 that is a stabilized value and used for emitting a laser light beam at a power level of the second power intensity P2 at the start of recording test data in an OPC operation in step S109, the degradation of recording quality immediately after the start of recording test data in an OPC operation can be prevented.

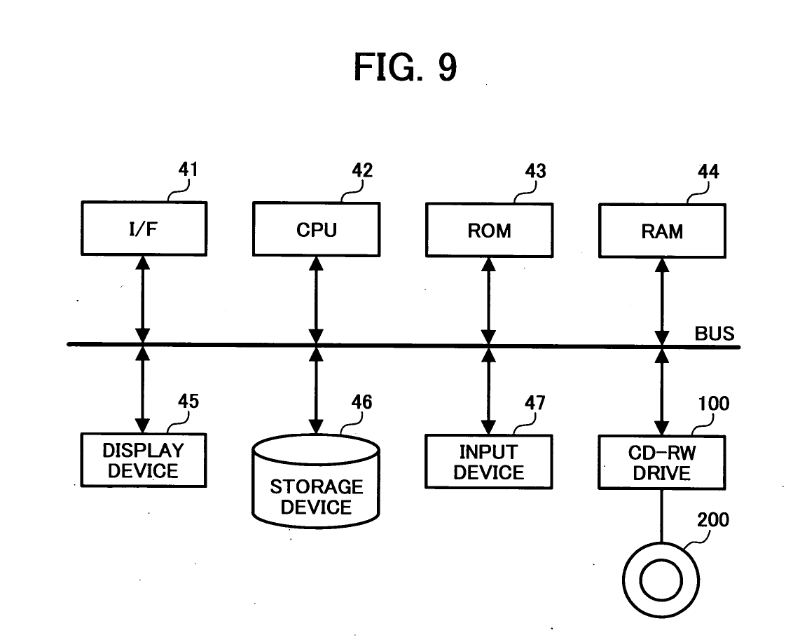

FIG. 9 is a block diagram of a configuration of an information processing system including the above-described optical information recording and reproducing apparatus of FIG. 7. In the information processing system, the above-described operation for determining a value of current supplied to the LD is performed by using software based on a computer program. The information processing system includes an interface (I/F) 41, a CPU 42, a ROM 43, a RAM 44, a display device 45, a storage device 46 such as a Hard Disk, an input device 47, and the optical information recording and reproducing apparatus 100. The input device 47 may be at least one of various input media, such as a keyboard, a mouse, and/or a pointing device, etc. The input device 47 notifies the CPU 42 of various types of information input by an operator. The display device 45 may include a Cathode-Ray Tube (CRT), a Liquid Crystal Display (LCD) and a Plasma Display Panel (PDP), etc. The display device 45 displays various types of information from the CPU 42.

A computer program is stored in the storage device 46. The computer program may be downloaded from a communication network such as the Internet via the interface 41 and installed in the storage device 46. Then, the computer program stored in the storage device 46 is installed as a firmware in the ROM 116 such as an electrically erasable programmable ROM (EEPROM) and a flash memory. The CPU 118 starts computer program automatically or when a control signal is input to the information processing system from an external device through the interface 41. Alternatively, the CPU 118 starts computer program in accordance with an instruction input by an operator through the input device 47. The CPU 118 shown in FIG. 7 performs processing with respect to the above-described operation for determining a value of current supplied to the LD based on the computer program. The CPU 118 stores a process result in the RAM 44 and the storage device 46, and causes the process result to display on the display device 45 if necessary.

The present invention has been described with respect to the exemplary embodiments illustrated in the figures. However, the present invention is not limited to these embodiments and may be practiced otherwise.

As an alternative to the CD-RW drive, the optical information recording and reproducing apparatus 100 may be a DVD-RW drive and a DVD+RW drive. Further, the optical disk 200 may be a DVD-RW disk and a DVD+RW disk in place of the CD-RW disk.

Numerous additional modifications and variations of the present invention are possible in light of the above teachings. It is therefore understood that within the scope of the appended claims, the present invention may be practiced other than as specifically described herein.

1. An optical information recording and reproducing apparatus, comprising:
a laser light source configured to emit a digitally modulated laser light beam to an optical recording medium including a light-emitting power calibration area that is used for determining an optimum recording power intensity value of the laser light beam emitted from the laser light source and that includes a test area including a plurality of partitions into which test data is recorded and includes a count area including a plurality of partitions corresponding to the partitions of the test area, the laser light beam emitted from the laser light source including a laser light beam of first power intensity, a laser light beam of second power intensity greater than the first power intensity, and a laser light beam of third power intensity greater than the second power intensity;
a laser light source drive mechanism configured to supply current to the laser light source and drive the laser light source;
a light-emitting power detecting mechanism configured to detect a light-emitting power of the laser light beam emitted from the laser light source;
a power intensity adjusting mechanism configured to adjust a power intensity of the laser light beam emitted from the laser light source based on the light-emitting power detected by the light-emitting power detecting mechanism by changing a value of the current supplied to the laser light source by the laser light source drive mechanism;
an optimum recording power intensity value determining mechanism configured to determine the optimum recording power intensity value of the laser light beam emitted from the laser light source by recording the test data into one of the partitions of the test area with at least the laser light beam of the third power intensity and the laser light beam of the second power intensity while variously changing the value of the third power intensity and the value of the second power intensity, and by reproducing the test data;
a laser efficiency value obtaining mechanism configured to obtain a laser efficiency value of the laser light source by causing the laser light source to emit a laser light beam of predetermined power intensity continuously to the one of the partitions of the test area at a constant power intensity value before recording the test data into the one of the partitions, by obtaining a plurality of values of current supplied to the laser light source during a period in which the laser efficiency value obtaining mechanism causes the laser light source to emit the laser light beam of the predetermined power intensity, and by calculating the laser efficiency value of the laser light source based on the plurality of obtained values of current; and
a current value determining mechanism configured to determine a third value of current required to be supplied to the laser light source to emit the laser light beam of the third power intensity when recording the test data into the one of the partitions of the test area based on the laser efficiency value of the laser light source obtained by the laser efficiency value obtaining mechanism, and configured to determine a second value of current required to be supplied to the laser light source to emit the laser light beam of the second power intensity at the start of recording the test data into the one of the partitions of the test area based on the laser efficiency value of the laser light source obtained by the laser efficiency value obtaining mechanism.

2. The optical information recording and reproducing apparatus according to claim 1, wherein the laser efficiency value obtaining mechanism is configured to obtain the plurality of values of current supplied to the laser light source by excluding a predetermined number of values of current supplied to the laser light source immediately after the start of emission of the laser light beam of the predetermined power intensity from the laser light source.

3. The optical information recording and reproducing apparatus according to claim 1, further comprising:
a maximum current value changing mechanism configured to change a maximum value of current supplied to the laser light source according to the plurality of values of current obtained by the laser efficiency value obtaining mechanism.

4. The optical information recording and reproducing apparatus according to claim 2,
wherein a first value of current is supplied to the laser light source to emit the laser light beam of the first power intensity from the laser light source, the first value of current and the second value of current are supplied to the laser light source to emit the laser light beam of the second power intensity from the laser light source, and the first value of current, the second value of current, and the third value of current are supplied to the laser light source to emit the laser light beam of the third power intensity from the laser light source,
wherein the predetermined power intensity of the laser light beam emitted continuously to the one of the partitions of the test area is greater than the first power intensity, and the first value of current and a predetermined value of current are supplied to the laser light source to emit the laser light beam of the predetermined power intensity from the laser light source,
wherein the laser efficiency value obtaining mechanism is configured to obtain an average current value of the plurality of the predetermined values of current,
wherein the laser efficiency value obtaining mechanism is configured to obtain the laser efficiency value (EV) of the laser light source by a following equation,
EV=(Per−P1)/Z
where Per is the predetermined power intensity of the laser light beam emitted continuously to the one of the partitions of the test area, P1 is the first power intensity, and Z is the average current value of the plurality of the predetermined values of current obtained by the laser efficiency value obtaining mechanism,
wherein the current value determining mechanism is configured to determine the third value of current (IP3) required to be supplied to the laser light source to emit the laser light beam of the third power intensity from the laser light source by a following equation,
IP3=(P3−P2)/EV
where P3 is the third power intensity, P2 is the second power intensity, and EV is the laser efficiency value, and
wherein the current value determining mechanism is configured to determine the second value of current (IP2) required to be supplied to the laser light source to emit the laser light beam of the second power intensity from the laser light source by a following equation,
IP2=(P2−P1)/EV
where P2 is the second power intensity, P1 is the first power intensity, and EV is the laser efficiency value.

5. The optical information recording and reproducing apparatus according to claim 4,
wherein the power intensity adjusting mechanism includes a first data setting mechanism configured to set first data corresponding to the first value of current to be supplied to the laser light source by the laser light source drive mechanism, a second data setting mechanism configured to set second data corresponding to the second value of current to be supplied to the laser light source by the laser light source drive mechanism, and a third data setting mechanism configured to set third data corresponding to the third value of current to be supplied to the laser light source by the laser light source drive mechanism, and
wherein the second data setting mechanism further sets predetermined data corresponding to the predetermined value of current to be supplied to the laser light source by the laser light source drive mechanism to emit the laser light beam of the predetermined power intensity continuously to the one of the partitions of the test area from the laser light source.

6. A method of determining a value of current supplied to a laser light source that emits at least a laser light beam of first power intensity, a laser light beam of second power intensity greater than the first power intensity, and a laser light beam of third power intensity greater than the second power intensity to record information data into a recording medium, the method comprising steps of:
causing the laser light source to emit a laser light beam of predetermined power intensity continuously at a constant power intensity value during a predetermined period to a test area in the recording medium to be used for determining an optimum recording power intensity value of the laser light beam emitted from the laser light source;
obtaining a laser efficiency value of the laser light source based on a relation between the predetermined power intensity of the laser light beam emitted continuously from the laser light source to the test area and a value of current supplied to the laser light source during the predetermined period in which the laser light beam of the predetermined power intensity is continuously emitted to the test area;
determining a third value of current required to be supplied to the laser light source to emit the laser light beam of the third power intensity from the laser light source when recording test data into the test area based on the laser efficiency value of the laser light source; and
determining a second value of current required to be supplied to the laser light source to emit the laser light beam of the second power intensity from the laser light source at the start of recording the test data into the test area based on the laser efficiency value of the laser light source.

7. The method according to claim 6, wherein the obtaining step comprises:
obtaining a plurality of values of current supplied to the laser light source during the predetermined period in which the laser light beam of the predetermined power intensity is continuously emitted to the test area, by excluding a predetermined number of values of current supplied to the laser light source immediately after the start of emission of the laser light beam of the predetermined power intensity from the laser light source.

8. The method according to claim 7, further comprising:
changing a maximum value of current supplied to the laser light source according to the plurality of values of current.

9. The method according to claim 7,
wherein a first value of current is supplied to the laser light source to emit the laser light beam of the first power intensity from the laser light source, the first value of current and the second value of current are supplied to the laser light source to emit the laser light beam of the second power intensity from the laser light source, and the first value of current, the second value of current, and the third value of current are supplied to the laser light source to emit the laser light beam of the third power intensity from the laser light source,
wherein the predetermined power intensity of the laser light beam emitted continuously to the test area is greater than the first power intensity, and the first value of current and a predetermined value of current are supplied to the laser light source to emit the laser light beam of the predetermined power intensity from the laser light source,
wherein the obtaining step comprises:
obtaining an average current value of the plurality of the predetermined values of current,
wherein the laser efficiency value (EV) of the laser light source is obtained by a following equation,
EV=(Per−P1)/Z
where Per is the predetermined power intensity of the laser light beam emitted continuously to the test area, P1 is the first power intensity, and Z is the average current value of the plurality of the predetermined values of current,
wherein the third value of current (IP3) required to be supplied to the laser light source to emit the laser light beam of the third power intensity from the laser light source is determined by a following equation,
IP3=(P3−P2)/EV
where P3 is the third power intensity, P2 is the second power intensity, and EV is the laser efficiency value, and
wherein the second value of current (IP2) required to be supplied to the laser light source to emit the laser light beam of the second power intensity from the laser light source is determined by a following equation,
IP2=(P2−P1)/EV
where P2 is the second power intensity, P1 is the first power intensity, and EV is the laser efficiency value.

10. A computer program comprising program code means that, when executed by a controller of an optical information recording and reproducing apparatus, instructs the apparatus to carry out a method of determining a value of current supplied to a laser light source that emits at least a laser light beam of first power intensity, a laser light beam of second power intensity greater than the first power intensity, and a laser light beam of third power intensity greater than the second power intensity to record information data into a recording medium, the method comprising steps of:
causing the laser light source to emit a laser light beam of predetermined power intensity continuously at a constant power intensity value during a predetermined period to a test area in the recording medium to be used for determining an optimum recording power intensity value of the laser light beam emitted from the laser light source;
obtaining a laser efficiency value of the laser light source based on a relation between the predetermined power intensity of the laser light beam emitted continuously from the laser light source to the test area and a value of current supplied to the laser light source during the predetermined period in which the laser light beam of the predetermined power intensity is continuously emitted to the test area;
determining a third value of current required to be supplied to the laser light source to emit the laser light beam of the third power intensity from the laser light source when recording test data into the test area based on the laser efficiency value of the laser light source; and
determining a second value of current required to be supplied to the laser light source to emit the laser light beam of the second power intensity from the laser light source at the start of recording the test data into the test area based on the laser efficiency value of the laser light source.

11. The program according to claim 10, wherein the obtaining step comprises:
obtaining a plurality of values of current supplied to the laser light source during the predetermined period in which the laser light beam of the predetermined power intensity is continuously emitted to the test area, by excluding a predetermined number of values of current supplied to the laser light source immediately after the start of emission of the laser light beam of the predetermined power intensity from the laser light source.

12. The program according to claim 11, further comprising:
changing a maximum value of current supplied to the laser light source according to the plurality of values of current.

13. The program according to claim 11,
wherein a first value of current is supplied to the laser light source to emit the laser light beam of the first power intensity from the laser light source, the first value of current and the second value of current are supplied to the laser light source to emit the laser light beam of the second power intensity from the laser light source, and the first value of current, the second value of current, and the third value of current are supplied to the laser light source to emit the laser light beam of the third power intensity from the laser light source,
wherein the predetermined power intensity of the laser light beam emitted continuously to the test area is greater than the first power intensity, and the first value of current and a predetermined value of current are supplied to the laser light source to emit the laser light beam of the predetermined power intensity from the laser light source,
wherein the obtaining step comprises:
obtaining an average current value of the plurality of the predetermined values of current,
wherein the laser efficiency value (EV) of the laser light source is obtained by a following equation,
EV=(Per−P1)/Z
where Per is the predetermined power intensity of the laser light beam emitted continuously to the test area, P1 is the first power intensity, and Z is the average current value of the plurality of the predetermined values of current,
wherein the third value of current (IP3) required to be supplied to the laser light source to emit the laser light beam of the third power intensity from the laser light source is determined by a following equation,
IP3=(P3−P2)/EV
where P3 is the third power intensity, P2 is the second power intensity, and EV is the laser efficiency value, and
wherein the second value of current (IP2) required to be supplied to the laser light source to emit the laser light beam of the second power intensity from the laser light source is determined by a following equation,
IP2=(P2−P1)/EV
where P2 is the second power intensity, P1 is the first power intensity, and EV is the laser efficiency value.

14. A computer readable storage medium storing a computer program comprising program code means that, when executed by a controller of an optical information recording and reproducing apparatus, instructs the apparatus to carry out a method of determining a value of current supplied to a laser light source that emits at least a laser light beam of first power intensity, a laser light beam of second power intensity greater than the first power intensity, and a laser light beam of third power intensity greater than the second power intensity to record information data into a recording medium, the method comprising steps of:
causing the laser light source to emit a laser light beam of predetermined power intensity continuously at a constant power intensity value during a predetermined period to a test area in the recording medium to be used for determining an optimum recording power intensity value of the laser light beam emitted from the laser light source;
obtaining a laser efficiency value of the laser light source based on a relation between the predetermined power intensity of the laser light beam emitted continuously from the laser light source to the test area and a value of current supplied to the laser light source during the predetermined period in which the laser light beam of the predetermined power intensity is continuously emitted to the test area;
determining a third value of current required to be supplied to the laser light source to emit the laser light beam of the third power intensity from the laser light source when recording test data into the test area based on the laser efficiency value of the laser light source; and
determining a second value of current required to be supplied to the laser light source to emit the laser light beam of the second power intensity from the laser light source at the start of recording the test data into the test area based on the laser efficiency value of the laser light source.

15. The medium according to claim 14, wherein the obtaining step comprises:
obtaining a plurality of values of current supplied to the laser light source during the predetermined period in which the laser light beam of the predetermined power intensity is continuously emitted to the test area, by excluding a predetermined number of values of current supplied to the laser light source immediately after the start of emission of the laser light beam of the predetermined power intensity from the laser light source.

16. The medium according to claim 15, further comprising:
changing a maximum value of current supplied to the laser light source according to the plurality of values of current.

17. The medium according to claim 15,
wherein a first value of current is supplied to the laser light source to emit the laser light beam of the first power intensity from the laser light source, the first value of current and the second value of current are supplied to the laser light source to emit the laser light beam of the second power intensity from the laser light source, and the first value of current, the second value of current, and the third value of current are supplied to the laser light source to emit the laser light beam of the third power intensity from the laser light source,
wherein the predetermined power intensity of the laser light beam emitted continuously to the test area is greater than the first power intensity, and the first value of current and a predetermined value of current are supplied to the laser light source to emit the laser light beam of the predetermined power intensity from the laser light source,
wherein the obtaining step comprises:
obtaining an average current value of the plurality of the predetermined values of current,
wherein the laser efficiency value (EV) of the laser light source is obtained by a following equation,
EV=(Per−P1)/Z
where Per is the predetermined power intensity of the laser light beam emitted continuously to the test area, P1 is the first power intensity, and Z is the average current value of the plurality of the predetermined values of current,
wherein the third value of current (IP3) required to be supplied to the laser light source to emit the laser light beam of the third power intensity from the laser light source is determined by a following equation,
IP3=(P3−P2)/EV
where P3 is the third power intensity, P2 is the second power intensity, and EV is the laser efficiency value, and
wherein the second value of current (IP2) required to be supplied to the laser light source to emit the laser light beam of the second power intensity from the laser light source is determined by a following equation,
IP2=(P2−P1)/EV
where P2 is the second power intensity, P1 is the first power intensity, and EV is the laser efficiency value.
